(19) United States
(12) Patent Application Publication
(10) Pub. No.: US 2024/0099377 A1
(43) Pub. Date: Mar. 28, 2024

(54) AEROSOL GENERATING DEVICE

(71) Applicant: NICOVENTURES TRADING LIMITED, London (GB)

(72) Inventors: Anton KORUS, London (GB); Luke WARREN; Patrick MOLONEY, London (GB); Matthew HODGSON, London (GB)

(21) Appl. No.: 18/257,776

(22) PCT Filed: Dec. 22, 2021
(86) PCT No.: PCT/EP2021/087382

§ 371 Date: Jun. 15, 2023

(30) Foreign Application Priority Data
Dec. 22, 2020 (GB) 2020398.0

(51) Int. Cl. A24F 40/465

(52) U.S. Cl. CPC A24F 40/465

(57) ABSTRACT

An aerosol generating device is disclosed and includes a device housing, a planar non-spiral inductor coil and a power supply connected to the planar non-spiral inductor coil, the power supply configured to provide an oscillating current to the planar non-spiral inductor coil.

### PRIORITY CLAIM

The present application is a National Phase Entry of PCT Application No. PCT/EP2021/087382, filed Dec. 22, 2021, which claims priority from GB Application No. 2020398.0, filed Dec. 22, 2020, each of which are hereby fully incorporated by reference.

### TECHNICAL FIELD

The present disclosure relates to an aerosol generating device, an aerosol generating system, a method of generating an aerosol, a method of fabricating an aerosol generating device and an aerosol provision device.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use induction heating systems as heaters to create an aerosol from a suitable medium. An induction heating system generally consists of a magnetic field generating device for generating a varying magnetic field, and a susceptor or heating material which is heatable by penetration with the varying magnetic field to heat the suitable medium.

Many different magnetic field generating devices are known, such as a three dimensional inductor coil. However, there are a variety of constraints, such as the available space, size of device, and power requirements, which places a restriction on the types of magnetic field generating devices. Furthermore, there are a variety of parameters which limit the efficiency of the inductive coupling between the magnetic field generating device and the susceptor or heating material. For example, such parameters include the separation between the magnetic field generating device and the susceptor or heating material, or the relative area sizes and orientations thereof.

It is desired to provide an improved aerosol generating device.

### SUMMARY

According to aspect there is provided an aerosol generating device comprising:
a device housing;
a planar non-spiral inductor coil; and
a power supply connected to the planar non-spiral inductor coil, the power supply configured to provide a oscillating current to the planar non-spiral inductor coil.

A planar non-spiral coil it is intended to be understood as comprising a coil having an axis where the winding or turning of the coil is normal to the surface in which the inductor coil lies.

The inductor coil may be substantially square.

The inductor coil may be substantially rectangular.

The device may comprise two or more planar non-spiral inductor coils.

Using two or more coils may lead to improved heating of the subsector element. Improved heating of the susceptor element may increase the amount of aerosol generated.

The system may further comprise a flux concentrator.

The flux concentrator may comprise ferrite material.

The ferrite material may be in the form of a continuous sheet or strip.

The inductor coil may comprise a plurality of mandrel loops or loops, the plurality of mandrel loops or loops being arranged in a multiple layer configuration.

The mandrel loops or loops may comprise single turn coils. Alternatively, the mandrel loops or loops may comprise a plurality of turn coils.

Optionally, the mandrel loops or loops comprise one, two, three or four turn coils.

The mandrel loops or loops may be disposed on a printable circuit board (PCB).

The aerosol generating device may comprise a plurality of planar non-spiral inductor coils.

The one or more planar non-spiral inductor coils may be configured to generate a varying magnetic field, optionally wherein the one or more planar non-spiral inductor coils may be configured to generate a respective varying magnetic field from each one of the conically shaped inductor coils, wherein each of the respective varying magnetic fields are generated independently of each other.

In an embodiment, the plurality of conically shaped inductor coils are independently operable. The plurality of conically shaped inductor coils may be configured to independently heat the one or more susceptors.

### FIELD

The one or more susceptors may be arranged to become heated by the varying magnetic field.

The one or more susceptors may be arranged and adapted to heat but not burn aerosolizable material provided in an article for use with a non-combustible aerosol provision device.

The article may be a substantially flat article. The article may comprise a plurality of discrete portions of aerosolizable material. The article may comprise a substantially flat consumable.

The one or more susceptors may be arranged and adapted to generate aerosol from aerosolizable material provided in an article for use with a non-combustible aerosol provision device.

The aerosol generating device may comprise a heat not burn aerosol generating device.

The aerosol generating device may comprise a non-combustible aerosol provision device.

According to another aspect there is provided an aerosol generating system comprising an aerosol generating device as described above and an article for use with a non-combustible aerosol provision device.

The article for use with a non-combustible aerosol provision device may comprise one or more susceptors, and the one or more planar non-spiral inductor coils may be configured to generate a varying magnetic field and wherein the one or more susceptors may be arranged to become heated by the varying magnetic field.

The article for use with a non-combustible aerosol provision device may comprise aerosolizable material.

The aerosolizable material may be provided: (i) as a solid; (ii) as a liquid; (ii) in the form of a gel; (iv) in the form of a thin film substrate; (iv) in the form of a thin film substrate having multiple regions; (v) in the form of a thin film substrate having multiple regions, wherein at least two of the regions comprise aerosolizable material having different compositions.

According to another aspect there is provided a method of generating an aerosol comprising, providing an aerosol generating device as described above and inserting an article for use with a non-combustible aerosol provision device comprising aerosolizable material into the aerosol generating device.

According to another aspect there is provided an aerosol generating system comprising:
an aerosol generating device comprising one or more planar non-spiral inductor coils;
an article for use with a non-combustible aerosol provision device located, in use, within the aerosol generating device; and
one or more removable susceptors.

According to another aspect there is provided an aerosol generating system comprising:
an aerosol generating device; and
an article for use with a non-combustible aerosol provision device located, in use, within the aerosol generating device, wherein the article for use with a non-combustible aerosol provision device comprises one or more planar non-spiral inductor coils and/or one or more susceptors.

According to another aspect there is provided a method of fabricating an aerosol generating device, the method comprising:
forming a device housing together with a planar non-spiral inductor coil; and
connecting a power supply to the planar non-spiral inductor coil, the power supply configured to provide an oscillating current to the planar non-spiral inductor coil.

According to another aspect there is provided an aerosol provision device comprising:
a plate or printed circuit board having an aperture for receiving an aerosol generating article;
a first planar non-spiral inductor coil provided on a first side of the plate or printed circuit board; and
a second planar non-spiral inductor coil provided on a second opposite side of the plate or printed circuit board.

### BRIEF DESCRIPTION OF THE DRAWINGS

Various embodiments of the present disclosure will now be described, by way of example only, with reference to the accompanying drawings, in which:

FIG. 1 shows a schematic perspective view of an example of a planar non-spiral induction coil for use in an aerosol generating device;

FIG. 2 shows a schematic side view of an example of an electrically-heated aerosol generating system; and

FIG. 3 shows a schematic perspective view of an example of a planar non-spiral induction coil arrangement in the form of a mandrel loop or loop according to an embodiment.

### DETAILED DESCRIPTION

As used herein, the term “aerosol generating material” which may also be referred to as “aerosolizable material” includes materials that provide volatilized components upon heating, typically in the form of vapor or an aerosol. “Aerosolizable material” may be a non-tobacco-containing material or a tobacco-containing material. “Aerosolizable material” may, for example, include one or more of tobacco per se, tobacco derivatives, expanded tobacco, reconstituted tobacco, tobacco extract, homogenized tobacco or tobacco substitutes. The aerosolizable material can be in the form of ground tobacco, cut rag tobacco, extruded tobacco, reconstituted tobacco, reconstituted aerosolizable material, liquid, gel, a solid, gelled sheet, powder, beads, granules, or agglomerates, or the like. “Aerosolizable material” also may include other, non-tobacco, products, which, depending on the product, may or may not contain nicotine. “Aerosolizable material” may comprise one or more humectants, such as glycerol or propylene glycol.

A susceptor is material that is heatable by penetration with a varying magnetic field, such as an alternating magnetic field. The heating material may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The heating material may be both electrically-conductive and magnetic, so that the heating material is heatable by both heating mechanisms.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents.

Therefore, when such eddy currents are generated in the object, their flow against the electrical resistance of the object causes the object to be heated. This process is called Joule, ohmic, or resistive heating.

In one example, the susceptor is in the form of a closed circuit. It has been found that, when the susceptor is in the form of a closed circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

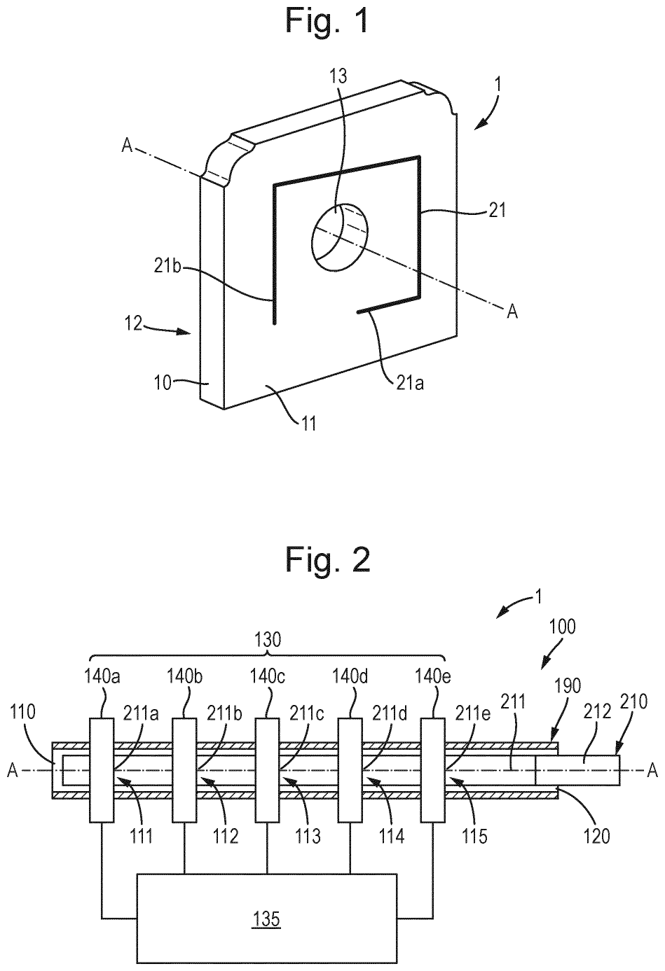

Referring to FIG. 1, there is shown a schematic of a perspective view of an example of an induction coil arrangement according to an embodiment. The induction coil arrangement 1 is for use with an aerosol generating system comprising an aerosol generating device, such as the device 100 as shown in FIG. 2 and further described below.

The induction coil arrangement 1 comprises a board, panel or plate 10 and two planar non-spiral inductor coils 21 (second not shown) of electrically-conductive material, such as copper. In other examples, there may only be one inductor coil 21. In use, a varying (e.g. alternating) electric current is passed through each of the coils 21 so as to create a varying (e.g. alternating) magnetic field that is usable to penetrate a heating element to cause heating of the heating element, as will be described in more detail below.

The plate 10 has a first side 11 and an opposite second side 12. The first and second sides 11,12 of the plate 10 face away from each other. In this embodiment, the plate 10 is substantially planar, and the first and second sides 11,12 are major sides of the plate 10. The plate 10 may be made from a non-electrically-conductive material, such as a plastics material, so as to electrically-insulate the coils 21, from each other. In this embodiment, the plate 10 is made from FR-4, which is a composite material composed of woven fiberglass cloth with an epoxy resin binder that is flame retardant. A first of the planar non-spiral inductor coils 21 which may comprise electrically-conductive material may be mounted on the first side 11 of the plate 10, and a second of the planar non-spiral inductor coils 21 of electrically-conductive material may be mounted on the second side 12 of the plate 10. Accordingly, the plate 10 is located between the coils 21.

An aperture 13 may be provided in the plate 10. In use, an aerosol generating article and/or a susceptor may be introduced within the aperture 13.

The or at least one of the planar non-spiral inductor coils 21 may be in the form of a square or rectangular helix.

The coils 21, may be affixed to the plate 10 in any suitable way. In this embodiment, the induction coil arrangement 1 has been formed from printed circuit board (PCB), and so the first and second planar non-spiral coils 21, have been formed by printing the electrically-conductive material onto the respective first and second sides 11,12 of the board or plate 10 during manufacture of the PCB, and then removing (such as by etching) selective portions of the electrically-conductive material so that patterns of the electrically-conductive material in the form of the first and second flat spiral coils 21, remain on the plate 10. Accordingly, the first and second planar non-spiral coils 21, are thin films or coatings of electrically-conductive material on the plate 10.

The first and second planar non-spiral coils 21 may be formed as an open loop having a first end 21a and a second end 21b.

In other examples, the coils may be isolated or separated from one another i.e. not connected or formed from a PCB, with the plate 10 not being present.

The induction coil arrangement 1 of this embodiment therefore comprises a laminate having a first layer (comprising the first planar non-spiral coil 21), a second layer (comprising the second planar non-spiral inductor coil), and an intermediate third layer (the plate 10) between the first and second layers. The plate 10 thus spaces apart the first and second layers. As the plate 10 is made of non-electrically-conductive material, the coils 21 are electrically insulated from each other (other than for the electrically-conductive connector 30, discussed below). That is, the coils 21 are out of contact with each other. In other embodiments, the coils 21 may be electrically insulated from each other in a different way, such as by an air gap between the coils 21. In some embodiments, the coils 21 may be provided on the plate 10 in any other suitable way, such as by being pre-formed and then attached to the plate 10.

In some embodiments, the plate 10 may be formed other than a layer of a PCB. For example, it may be a layer or sheet of material such as resin or adhesive, which may have dried, cured or solidified.

The use of coils formed from thin, printed electrically-conductive material as discussed above obviates the need for LITZ® wire. The latter is comprised of many strands of extremely thin wire gathered in a braid, in order to overcome the effects of diminishing skin depth at higher excitation frequencies. As the tracks on a PCB are 25 μm thin (typically around 38 μm thick for 1 oz Cu and around 76 μm thick for 2 oz Cu), their performance at high frequencies can be comparable to the equivalent cross-sectional area of LITZ® wire, yet without problems arising in relation to brittleness, shaping the LITZ® wire, or connecting it to other components.

The first and second planar non-spiral coils 21 are exposed on the plate 10, which helps enable the dissipation of any heat generated in the coils 21, during use. However, in other embodiments the first and second planar non-spiral coils 21, may instead be embedded within material that forms the plate 10, to help protect the coils 21, from damage during transportation, storage and use.

Referring to FIG. 2, there is shown a schematic cross-sectional side view of an example of an aerosol generating system. The system 1 comprises an aerosol generating device 100 and an aerosol generating article 210 comprising aerosolizable material 211. The aerosolizable material 211 may, for example, be of any of the types of aerosolizable material discussed herein. In this example, the aerosol-generating device 100 is a tobacco heating product (also known in the art as a tobacco heating device or a heat-not-burn device).

In some examples, the aerosolizable material 211 is a non-liquid material. In some examples, the aerosolizable material 211 is a gel. In some examples, the aerosolizable material 211 comprises tobacco. However, in other examples, the aerosolizable material 211 may consist of tobacco, may consist substantially entirely of tobacco, may comprise tobacco and aerosolizable material other than tobacco, may comprise aerosolizable material other than tobacco, or may be free from tobacco. In some examples, the aerosolizable material 211 may comprise a vapor or aerosol forming agent or a humectant, such as glycerol, propylene glycol, triacetin, or diethylene glycol. In some examples, the aerosolizable material 211 comprises reconstituted aerosolizable material, such as reconstituted tobacco.

In some examples, the aerosolizable material 211 is substantially cylindrical with a substantially circular cross section and a longitudinal axis. In other examples, the aerosolizable material 211 may have a different cross-sectional shape and/or not be elongate.

The aerosolizable material 211 of the aerosol generating article 210 may, for example, have an axial length of between 8 mm and 120 mm. For example, the axial length of the aerosolizable material 211 may be greater than 9 mm, or 10 mm, or 15 mm, or 20 mm. For example, the axial length of the aerosolizable material 211 may be less than 100 mm, or 75 mm, or 50 mm, or 40 mm.

In some examples, such as that shown in FIG. 2 the aerosol generating article 210 comprises a filter arrangement 212 for filtering aerosol or vapor released from the aerosolizable material 211 in use. Alternatively, or additionally, the filter arrangement 212 may be for controlling the pressure drop over a length of the article. The filter arrangement 212 may comprise one, or more than one, filter. The filter arrangement 212 could be of any type used in the tobacco industry. For example, the filter may be made of cellulose acetate. In some examples, the filter arrangement 212 is substantially cylindrical with a substantially circular cross section and a longitudinal axis. In other examples, the filter arrangement 212 may have a different cross-sectional shape and/or not be elongate.

In some examples, the filter arrangement 212 abuts a longitudinal end of the aerosolizable material 211. In other examples, the filter arrangement 212 may be spaced from the aerosolizable material 211, such as by a gap and/or by one or more further components of the aerosol generating article 210. In some examples, the filter arrangement 212 may comprise an additive or flavor source (such as an additive- or flavor-containing capsule or thread), which may be held by a body of filtration material or between two bodies of filtration material, for example.

The aerosol generating article 210 may also comprise a wrapper (not shown) that is wrapped around the aerosolizable material 211 and the filter arrangement 212 to retain the filter arrangement 212 relative to the aerosolizable material 211. The wrapper may be wrapped around the aerosolizable material 211 and the filter arrangement 212 so that free ends of the wrapper overlap each other. The wrapper may form part of, or all of, a circumferential outer surface of the aerosol generating article 210. The wrapper could be made of any suitable material, such as paper, card, or reconstituted aerosolizable material (e.g. reconstituted tobacco). The paper may be a tipping paper that is known in the art. The wrapper may also comprise an adhesive (not shown) that adheres overlapped free ends of the wrapper to each other, to help prevent the overlapped free ends from separating. In other examples, the adhesive may be omitted, or the wrapper may take a different from to that described. In other examples, the filter arrangement 212 may be retained relative to the aerosolizable material 211 by a connector other than a wrapper, such as an adhesive. In some examples, the filter arrangement 212 may be omitted.

The aerosol generating device 100 comprises a heating zone 110 for receiving at least a portion of the aerosol generating article 210, an outlet 120 through which aerosol is deliverable from the heating zone 110 to a user in use, and heating apparatus 130 for causing heating of the aerosol generating article 210 when the aerosol generating article 210 is at least partially located within the heating zone 110 to thereby generate the aerosol. In some examples, such as that shown in FIG. 1, the aerosol is deliverable from the heating zone 110 to the user through the aerosol generating article 210 itself, rather than through any gap adjacent to the aerosol generating article 210. Nevertheless, in such examples, the aerosol still passes through the outlet 120, albeit while travelling within the aerosol generating article 210.

The device 100 may define at least one air inlet (not shown) that fluidly connects the heating zone 110 with an exterior of the device 100. A user may be able to inhale the volatilized component(s) of the aerosolizable material by drawing the volatilized component(s) from the heating zone 110 via the aerosol generating article 210. As the volatilized component(s) are removed from the heating zone 110 and the aerosol generating article 210, air may be drawn into the heating zone 110 via the air inlet(s) of the device 100.

In this example, the heating zone 110 extends along an axis A-A and is sized and shaped to accommodate only a portion of the aerosol generating article 210. In this example, the axis A-A is a central axis of the heating zone 110. Moreover, in this example, the heating zone 110 is elongate and so the axis A-A is a longitudinal axis A-A of the heating zone 110. The aerosol generating article 210 is insertable at least partially into the heating zone 110 via the outlet 120 and protrudes from the heating zone 110 and through the outlet 120 in use. In other examples, the heating zone 110 may be elongate or non-elongate and dimensioned to receive the whole of the aerosol generating article 210. In some such examples, the device 100 may include a mouthpiece that can be arranged to cover the outlet 120 and through which the aerosol can be drawn from the heating zone 110 and the aerosol generating article 210.

In this example, when the aerosol generating article 210 is at least partially located within the heating zone 110, different portions 211a-211e of the aerosolizable material 211 are located at different respective locations 110a-110e in the heating zone 110. In this example, these locations 110a-110e are at different respective axial positions along the axis A-A of the heating zone 110. Moreover, in this example, since the heating zone 110 is elongate, the locations 110a-110e can be considered to be at different longitudinally-spaced-apart positions along the length of the heating zone 110. In this example, the aerosol generating article 210 can be considered to comprise five such portions 211a-211e of the aerosolizable material 211 that are located respectively at a first location 110a, a second location 110b, a third location 110c, a fourth location 110d and a fifth location 110e. More specifically, the second location 110b is fluidly located between the first location 110a and the outlet 120, the third location 110c is fluidly located between the second location 110b and the outlet 120, the fourth location 110d is fluidly located between the third location 110c and the outlet 120, and the fifth location is fluidly located between the fourth location 110d and the outlet 120.

The heating apparatus 130 comprises plural heating units 140a-140e, each of which is able to cause heating of a respective one of the portions 211a-211e of the aerosolizable material 211 to a temperature sufficient to aerosolize a component thereof, when the aerosol generating article 210 is at least partially located within the heating zone 110. The plural heating units 140a-140e may be axially-aligned with each other along the axis A-A. Each of the portions 211a-211e of the aerosolizable material 211, heatable in this way may, for example, have a length in the direction of the axis A-A of between 1 millimeter and 20 millimeters, such as between 2 millimeters and 10 millimeters, between 3 millimeters and 8 millimeters, or between 4 millimeters and 6 millimeters.

The terms “heating units” used herein correspond to the planar non-spiral inductor coils as described in any of the examples of the foregoing as described with reference to FIG. 1.

The heating apparatus 130 of this example comprises five heating units 140a-140e, namely: a first heating unit 140a, a second heating unit 140b, a third heating unit 140c, a fourth heating unit 140d and a fifth heating unit 140e. The heating units 140a-140e are at different respective axial positions along the axis A-A of the heating zone 110. Moreover, in this example, since the heating zone 110 is elongate, the heating units 140a-140e can be considered to be at different longitudinally-spaced-apart positions along the length of the heating zone 110. More specifically, the second heating unit 140b is located between the first heating unit 140a and the outlet 120, the third heating unit 140c is located between the second heating unit 140b and the outlet 120, the fourth heating unit 140d is located between the third heating unit 140c and the outlet 120, and the fifth heating unit 140e is located between the fourth heating unit 140d and the outlet 120. In other examples, the heating apparatus 130 could comprise more than five heating units 140a-140e or fewer than five heating units, such as only four, only three, only two, or only one heating unit. The number of portion(s) of the aerosolizable material 211 that are heatable by the respective heating unit(s) may be correspondingly varied.

The heating units 140a-140e of this example comprise planar-non spiral inductor coils.

The heating apparatus 130 also comprises a controller 135 that is configured to cause operation of the heating units 140a-140e to cause the heating of the respective portions 211a-211e of the aerosolizable material 211 in use. In this example, the controller 135 is configured to cause operation of the heating units 140a-140e independently of each other, so that the respective portions 211a-211e of the aerosolizable material 211 can be heated independently. This may be desirable in order to provide progressive heating of the aerosolizable material 211 in use. Moreover, in examples in which the portions 211a-211e of the aerosolizable material 211 have different respective forms or characteristics, such as different tobacco blends and/or different applied or inherent flavors, the ability to independently heat the portions 211a-211e of the aerosolizable material 211 can enable heating of selected portions 211a-211e of the aerosolizable material 211 at different times during a session of use so as to generate aerosol that has predetermined characteristics that are time-dependent. In some examples, the heating apparatus 130 may nevertheless also be operable in one or more modes in which the controller 135 is configured to cause operation of more than one of the heating units 140a-140e, such as all of the heating units 140a-140e, at the same time during a session of use.

In this example, the heating units 140a-140e comprise respective planar non-spiral induction coils that are configured to generate respective varying magnetic fields, such as alternating magnetic fields. As such, the heating apparatus 130 can be considered to comprise a magnetic field generator, and the controller 135 can be considered to be apparatus that is operable to pass a varying electrical current through inductors of the respective heating units 140a-140e.

Moreover, in this example, the device 100 comprises a susceptor 190 that is configured so as to be heatable by penetration with the varying magnetic fields to thereby cause heating of the heating zone 110 and the aerosol generating article 210 therein in use. That is, portions of the susceptor 190 are heatable by penetration with the respective varying magnetic fields to thereby cause heating of the respective portions 211a-211e of the aerosolizable material 211 at the respective locations 110a-110e in the heating zone 110.

In some examples, the susceptor 190 is made of, or comprises, aluminum. However, in other examples, the susceptor 190 may comprise one or more materials selected from the group consisting of: an electrically-conductive material, a magnetic material, and a magnetic electrically-conductive material. In some examples, the susceptor 190 may comprise a metal or a metal alloy. In some examples, the susceptor 190 may comprise one or more materials selected from the group consisting of: aluminum, gold, iron, nickel, cobalt, conductive carbon, graphite, steel, plain-carbon steel, mild steel, stainless steel, ferritic stainless steel, molybdenum, silicon carbide, copper, and bronze. Other material(s) may be used in other examples.

In some examples, such as those in which the susceptor 190 comprises iron, such as steel (e.g. mild steel or stainless steel) or aluminum, the susceptor 190 may comprise a coating to help avoid corrosion or oxidation of the susceptor 190 in use. Such coating may, for example, comprise nickel plating, gold plating, or a coating of a ceramic or an inert polymer.

In this example, the susceptor 190 is tubular and encircles the heating zone 110. Indeed, in this example, an inner surface of the susceptor 190 partially delimits the heating zone 110. An internal cross-sectional shape of the susceptor 190 may be circular or a different shape, such as elliptical, polygonal, square, rectangular or irregular. In other examples, the susceptor 190 may take a different form, such as a non-tubular structure that still partially encircles the heating zone 110, or a protruding structure, such as a rod, pin or blade, that penetrates the heating zone 110. In some examples, the susceptor 190 may be replaced by plural susceptors, each of which is heatable by penetration with a respective one of the varying magnetic fields to thereby cause heating of a respective one of the portions 211a-211e of the aerosolizable material 211. Each of the plural susceptors may be tubular or take one of the other forms discussed herein for the susceptor 190, for example. In still further examples, the device 100 may be free from the susceptor 190, and the aerosol generating article 210 may comprise one or more susceptors that are heatable by penetration with the varying magnetic fields to thereby cause heating of the respective portions 211a-211e of the aerosolizable material 211. Each of the one or more susceptors 190 of the aerosol generating article 210 may take any suitable form, such as a structure (e.g. a metallic foil, such as an aluminum foil) wrapped around or otherwise encircling the aerosolizable material 211, a structure located within the aerosolizable material 211, or a group of particles or other elements mixed with the aerosolizable material 211. In examples in which the device 100 is free from the susceptor 190, the susceptor 190 may be replaced by a heat-resistant tube that partially delimits the heating zone 110. Such a heat-resistant tube may, for example, be made from polyether ether ketone (PEEK) or a ceramic material.

In other examples, the planar non-spiral induction coils may be arranged such that they are parallel with respect to the susceptor or plural susceptors and the axis A-A in other words they are arranged such that the planar face or side of the coil is parallel to the axis A-A e.g. such that the aerosol generating article 210 is not disposed axially with respect to the coils.

In other examples, the induction coils can be arranged such they heat an entire length or side of the susceptor.

In other examples, the planar non-spiral induction coils may be arranged such they form a square or rectangular enclosure around the susceptor 190 or plurality of susceptors 190, such that the entirety of the susceptor or plurality of susceptors are heated.

In this example, the heating apparatus 130 comprises an electrical power source (not shown) and a user interface (not shown) for user-operation of the device. The electrical power source of this example is a rechargeable battery. In other examples, the electrical power source may be other than a rechargeable battery, such as a non-rechargeable battery, a capacitor, a battery-capacitor hybrid, or a connection to a mains electricity supply.

In this example, the controller 135 is electrically connected between the electrical power source and the heating units 140a-140e. In this example, the controller 135 also is electrically connected to the electrical power source. More specifically, in this example, the controller 135 is for controlling the supply of electrical power from the electrical power source to the heating units 140a-140e. In this example, the controller 135 comprises an integrated circuit (IC), such as an IC on a printed circuit board (PCB). In other examples, the controller 135 may take a different form. The controller 135 is operated in this example by user-operation of the user interface. The user interface may comprise a push-button, a toggle switch, a dial, a touchscreen, or the like. In other examples, the user interface may be remote and connected to the rest of the aerosol provision device 100 wirelessly, such as via Bluetooth.

In this example, operation of the user interface by a user causes the controller 135 to cause an alternating electrical current to pass through the planar non-spiral inductor of at least one of the respective heating units 140a-140e. This causes the inductor to generate an alternating magnetic field. The inductor and the susceptor 190 are suitably relatively positioned so that the varying magnetic field produced by the inductor penetrates the susceptor 190. When the susceptor 190 is electrically-conductive, this penetration causes the generation of one or more eddy currents in the susceptor 190. The flow of eddy currents in the susceptor 190 against the electrical resistance of the susceptor 190 causes the susceptor 190 to be heated by Joule heating. When the susceptor 190 is magnetic, the orientation of magnetic dipoles in the susceptor 190 changes with the changing applied magnetic field, which causes heat to be generated in the susceptor 190.

The device 100 may comprise a temperature sensor (not shown) for sensing a temperature of the heating chamber 110, the susceptor 190 or the aerosol generating article 210. The temperature sensor may be communicatively connected to the controller 135, so that the controller 135 is able to monitor the temperature of the heating chamber 110, the susceptor 190 or the aerosol generating article 210, respectively, on the basis of information output by the temperature sensor. In other examples, the temperature may be sensed and monitored by measuring electrical characteristics of the system e.g. the change in current within the heating units 140a-140e. On the basis of one or more signals received from the temperature sensor, the controller 135 may cause a characteristic of the varying or alternating electrical current to be adjusted as necessary, in order to ensure that the temperature of the heating chamber 110, the susceptor 190 or the article, respectively, remains within a predetermined temperature range. The characteristic may be, for example, amplitude or frequency or duty cycle. Within the predetermined temperature range, in use the aerosolizable material 211 within the aerosol generating article 210 located in the heating chamber 110 is heated sufficiently to volatilize at least one component of the aerosolizable material 211 without combusting the aerosolizable material 211. Accordingly, the controller 135, and the device 100 as a whole, is arranged to heat the aerosolizable material 211 to volatilize the at least one component of the aerosolizable material 211 without combusting the aerosolizable material 211. The temperature range may be between about 50° C. and about 350° C., such as between about 100° C. and about 300° C., or between about 150° C. and about 280° C. In other examples, the temperature range may be other than one of these ranges. In some examples, the upper limit of the temperature range could be greater than 350° C. In some examples, the temperature sensor may be omitted.

In the foregoing examples, the size or extent of the varying magnetic fields as measured in the direction of the axis A-A is relatively small, so that the portions of the susceptor 190 that are penetrated by the varying magnetic fields in use are correspondingly small. Accordingly, it may be desirable for the susceptor 190 to have a thermal conductivity that is sufficient to increase the proportion of the susceptor 190 that is heated by thermal conduction as a result of the penetration by the varying magnetic fields, so as to correspondingly increase the proportion of the aerosolizable material 211 that is heated by operation of each of the heating units 140a-140e. It has been found that it is desirable to provide the susceptor 190 with a thermal conductivity of at least 10 W/m/K, optionally at least 50 W/m/K, and further optionally at least 100 W/m/K. In this example, the susceptor 190 is made of aluminum and has a thermal conductivity of over 200 W/m/K, such as between 200 and 250 W/m/K, for example approximately 205 W/m/K or 237 W/m/K. As noted above, each of the portions 211a-211e of the aerosolizable material 211 may, for example, have a length in the direction of the axis A-A of between 1 millimeter and 20 millimeters, such as between 2 millimeters and 10 millimeters, between 3 millimeters and 8 millimeters, or between 4 millimeters and 6 millimeters.

It will be understood that, for a given duration of heating session, the greater the number of heating units and associated portions of the aerosolizable material 211 there are, the greater the opportunity to generate aerosol from “fresh” or unspent portions of the aerosolizable material 211 extending along a given axial length. Alternatively, for a given duration of heating each portion of the aerosolizable material 211, the greater the number of heating units and associated portions of the aerosolizable material 211 there are, the longer the heating session may be. It should be appreciated that the duration for which an individual heating unit may be activated can be adjusted (e.g. shortened) to adjust (e.g. reduce) the overall heating session, and at the same time the power supplied to the heating element may be adjusted (e.g. increased) to reach the operational temperature more quickly. There may be a balance that is struck between the number of heating units (which may dictate the number of “fresh puffs”), the overall session length, and the achievable power supply (which may be dictated by the characteristics of the power source).

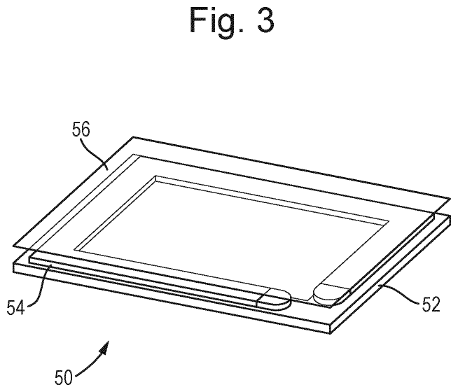

Referring now to FIG. 3, there is shown a schematic prospective view of an example of a planar non-spiral coil which is the form of a mandrel loop or loop, formed onto a PCB, according to an embodiment. A mandrel loop may be understood as comprising an open loop having a first end and a second end. The induction coil arrangement 50 is for use with an aerosol generating system, such as the one described above in relation to FIG. 2.

The induction coil arrangement 50 comprises a PCB 52, a planar non-spiral inductor coil disposed onto the PCB 52, in the form an of a mandrel loop or loop 54, disposed on top of the mandrel loop or loop 54 is an isolator 56. The mandrel loop or loop 54 is formed of electrically-conductive material, such as copper. In use, a varying (e.g. alternating) electric current is passed through the mandrel loop or loop 54 so as to create a varying (e.g. alternating) magnetic field that is usable to penetrate a heating element, such as the susceptor 190 of FIG. 2, to cause heating of the heating element, as will be described in more detail below.

Although this embodiment includes a PCB 52, other embodiments are contemplated wherein the mandrel loop or loop 52 is not disposed onto a PCB. Instead only the mandrel loop or loop 54 is present, or only the mandrel loop or loop 54 and isolator 56 are present.

In this particular embodiment, the mandrel loop or loop 54 comprises only a single turn. However, other embodiments are contemplated where the mandrel loop or loop 54 comprises more than one turn e.g. two turns, three turns, four turns or more than four turns.

The isolator 56 of this embodiment is in the form of planar plate. The isolator 56 may be made from a non-electrically-conductive material, such as a plastics material, so as to electrically-insulate the mandrel loop or loop 54. In this embodiment, the isolator 56 is made from FR-4, which is a composite material composed of woven fiberglass cloth with an epoxy resin binder that is flame retardant.

In some examples, when used in an aerosol generating system, a plurality of the induction coil arrangements 50 as described above may be used. The plurality of induction coil arrangements 50 can be arranged in a multiple layer configuration. In one example, there would only be a single PCB 52. According to this embodiment, a first mandrel loop or loop 54 is disposed on the PCB 52, and disposed on the first mandrel loop or loop 52 is a first isolator 56. A second mandrel loop or loop 54 may be disposed on the first isolator 56 and a second isolator 56 may be provided on the second mandrel loop or loop 54. This configuration can be repeated the required amount of times until specific requirements are met e.g. such that a required amount of flux density is achieved when a varying (e.g. alternating) electric current is passed through the plurality of mandrel loops or loops 54.

In other examples, rather than a single PCB 52, each respective layer may comprise its own PCB 52, mandrel loop or loop 54 and isolator 56.

In other examples, no respective PCB's 52 or isolators 56 are present, instead a plurality of mandrel loops or loops 54 are arranged in multiple layers. In such examples, the mandrel loops or loops 54 may be electrically insulated from each other in a different way, such as by an air gap. In other examples, only one mandrel loop or loop 54 is used.

Referring now to examples where a PCB 52 is present, the mandrel loop or loop 54 may be affixed to the PCB 52 in any suitable way. In the embodiment illustrated in FIG. 3, the induction coil arrangement 50 has been formed from printed circuit board (PCB) and so the mandrel loop or loop 54 has been formed by printing the electrically-conductive material onto the respective first and second sides 11, onto the PCB 52 during manufacture of the PCB 52, and then removing (such as by etching) selective portions of the electrically-conductive material so that patterns of the electrically-conductive material in the form of the mandrel loop or loop remain. Accordingly, mandrel loop or loop 54 is a thin film or coating of electrically-conductive material on the PCB 52.

It will be apparent therefore, that the mandrel loop or loop 54 configuration of any of the examples discussed in the foregoing may be used as a heating unit as described in the system of FIG. 3.

In some embodiments, the aerosol generating system is an electronic cigarette, also known as a vaping device or electronic nicotine delivery system (END), although it is noted that the presence of nicotine in the aerosol generating material is not a requirement.

In some embodiments, the aerosol generating system is a tobacco heating system, also known as a heat-not-burn system.

In some embodiments, the aerosol generating system is a hybrid system to generate aerosol using a combination of aerosol generating materials, one or a plurality of which may be heated. Each of the aerosol generating materials may be, for example, in the form of a solid, liquid or gel and may or may not contain nicotine. In some embodiments, the hybrid system comprises a liquid or gel aerosol generating material and a solid aerosol generating material. The solid aerosol generating material may comprise, for example, tobacco or a non-tobacco product.

Typically, the aerosol generating system may comprise an aerosol generating device and an article for use with the aerosol generating device. However, it is envisaged that articles which themselves comprise a means for powering an aerosol generating component may themselves form the aerosol generating system.

In some embodiments, the aerosol generating device may comprise a power source and a controller. The power source may, for example, be an electric power source.

In some embodiments, the article for use with the aerosol generating device may comprise an aerosol generating material, an aerosol generating component, an aerosol generating area, a mouthpiece, and/or an area for receiving aerosol generating material.

In some embodiments, the aerosol generating component is a heater capable of interacting with the aerosol generating material so as to release one or more volatiles from the aerosol generating material to form an aerosol.

In some embodiments, the substance to be delivered may be an aerosol generating material. Aerosol generating material, which also may be referred to herein as aerosol generating material, is material that is capable of generating aerosol, for example when heated, irradiated or energized in any other way.

In some embodiments, the aerosol generating article 210 is a consumable article or an article for use with a non-combustible aerosol provision device. Once all, or substantially all, of the volatilizable component(s) of the aerosolizable material 211 in the aerosol generating article 210 has/have been spent, the user may remove the aerosol generating article 210 from the heating zone 110 of the aerosol generating device 100 and dispose of the article 210. The user may subsequently re-use the aerosol generating device 100 with another aerosol generating article 210. However, in other respective embodiments, the aerosol generating article 210 may be non-consumable relative to the heating apparatus 130. That is, heating apparatus 130 and the aerosol generating article 210 may be disposed of together once the volatilizable component(s) of the aerosolizable material 211 has/have been spent.

In some embodiments, the aerosol generating article 210 is sold, supplied or otherwise provided separately from the aerosol generating device 100 with which the article 210 is usable. However, in some embodiments, the aerosol generating device 100 and one or more of the aerosol generating articles 210 may be provided together as a system, such as a kit or an assembly, possibly with additional components, such as cleaning utensils.

In some embodiments, the aerosol generating device 100 further comprises a flux concentrator, such as a magnetically permeable core. In some embodiments, the inductor coil as described above may be wound or wrapped around a portion of the flux concentrator. In other embodiments, the inductor coil may be adjacent to or embedded in the flux concentrator.

For example, the flux concentrator or magnetically permeable core concentrates the magnetic flux produced by an inductor coil in use and makes a more powerful magnetic field. Furthermore, the magnetically permeable core helps to direct the magnetic flux to its intended target. The intended target in the embodiments discussed above is one or more susceptors. In some embodiments, the coil may be wound around only a portion (i.e. not all) of the flux concentrator. In embodiments, the magnetically permeable core may have high magnetic permeability and low electrical conductivity. The latter helps prevent the generation of eddy currents in the magnetically permeable core in use, which helps to prevent the magnetically permeable core becoming heated in use.

The magnetically permeable core may comprise, or may be composed of, ferrite. The ferrite may, for example, contain iron oxide combined with nickel and/or zinc and/or manganese. The ferrite may have a low coercivity and be considered a “soft ferrite”, or have a high coercivity and be considered a “hard ferrite”. Example usable soft ferrites are manganese-zinc ferrite, with the formula MnaZn(i-a)Fe₂0₄, and nickel-zinc ferrite, with the formula NiaZn(i-a)Fe₂0₄. However, in respective variations to these embodiments, the magnetically permeable core may be made of a different material or materials. For example, in some embodiments, the magnetically permeable core may comprise plural layers of electrically-conductive material that are isolated from one another by non-electrically-conductive material. The magnetically permeable core may have dozens, or even hundreds, of layers of electrically-conductive material that are isolated from one another by non-electrically-conductive material. In embodiments comprising a plurality of induction coils, there may be provided a plurality of flux concentrators or magnetically permeable cores, wherein each one of the plurality of flux concentrators or magnetically permeable cores corresponds to a respective induction coil of the plurality of induction coils.

The aerosol generating device 100, aerosol generating system and the inductor coil according to various embodiments find particular utility when generating aerosol from a substantially flat aerosol generating article, in particular an aerosol generating article comprising a substantially flat consumable.

The substantially flat consumable may be provided in either an array or a circular format. Other arrangements are also contemplated.

The substantially flat consumable may be provided with a plurality of discrete portions of aerosolizable material. The plurality of discrete portions of aerosolizable material may be arranged in an array or grid-like configuration. The plurality of discrete portions of aerosolizable material may be arranged in a circular pattern.

In some embodiments e.g. wherein the substantially flat consumable is provided in the form of an array, multiple heating regions may be provided. For example, according to an embodiment one heating region may be provided per portion, pixel or zone/segment of the consumable.

In other embodiments, the substantially flat consumable may be rotated such that a segment of the consumable is heated by a similar shaped heater. According to this embodiment a single heating region may be provided.

In some embodiments the substantially flat consumable may be moved in one or more direction with respect a heating region.

In particular, the inductor coil according to various embodiments may be provided as part of a non-combustible aerosol provision device which is arranged to heat-not-burn a consumable as part of a non-combustible aerosol provision system. In particular, the consumable may comprise a plurality of discrete portions of aerosol-generating material, wherein each of the discrete portions comprises less than about 15 mg water.

In some embodiments, the aerosol-generating material is formed as a sheet. In some cases, the aerosol-generating material sheet may be incorporated into the assembly or consumable in sheet form, for example the plurality of discrete portions may be a plurality of sheets. The aerosol-generating material sheets may be incorporated as a planar sheets, as a gathered or bunched sheets, as a crimped sheets, or as rolled sheets (i.e. in the form of a tube). In some such cases, the aerosol-generating material of these embodiments may be included in an aerosol generating consumable/assembly as sheets, such as sheets circumscribing a rod of aerosol-generating material (e.g. tobacco). For example, the aerosol-generating material sheets may be formed on a wrapping paper which circumscribes an aerosol-generating material such as tobacco. In other cases, the sheets may be shredded and then incorporated into the assembly, suitably mixed into an aerosol-generating material such as cut rag tobacco. In such cases the consumables of the disclosure will retain the ability to aerosolize no more than 15 mg of water per inhalation action of the user, when the aerosol-generating material is heated to at least 120° C.

The consumable may comprise a support on which the aerosol-generating material is provided. The support functions as a support on which the aerosol-generating material forms, easing manufacture. The support may provide tensile strength to the aerosol-generating material, easing handling. In some cases, the plurality of discrete portions of aerosol-generating material are deposited on such a support. In some cases, the plurality of discrete portions of amorphous material is deposited on such a support. In some cases, the discrete portions of aerosol-generating material are deposited on such a support such that each discrete portion may be heated and aerosolized separately. In an exemplary embodiment the consumable comprises a plurality of discrete portions of aerosol-generating material comprising an, the discrete portions provided on a support and each of the discrete portions comprising less than 15 mg of water.

Suitably, the discrete portions of aerosol-generating material are provided on the support such that each discrete portion may be heated and aerosolized separately. It has been found that a consumable having such a conformation allows a consistent aerosol to be delivered to the user with each puff.

In some cases, the support may be formed from materials selected from metal foil, paper, carbon paper, greaseproof paper, ceramic, carbon allotropes such as graphite and graphene, plastic, cardboard, wood or combinations thereof. In some cases, the support may comprise or consist of a tobacco material, such as a sheet of reconstituted tobacco. In some cases, the support may be formed from materials selected from metal foil, paper, cardboard, wood or combinations thereof. In some cases, the support itself be a laminate structure comprising layers of materials selected from the preceding lists. In some cases, the support may also function as a flavorant carrier. For example, the support may be impregnated with a flavorant or with tobacco extract.

In some cases, the support may be non-magnetic.

In some cases, the support may be magnetic. This functionality may be used to fasten the support to the assembly in use, or may be used to generate particular shapes. In some cases, the aerosol-generating material may comprise one or more magnets which can be used to fasten the material to an induction heater in use.

In some cases, the support may be substantially or wholly impermeable to gas and/or aerosol. This prevents aerosol or gas passage through the support layer, thereby controlling the flow and ensuring it is delivered to the user. This can also be used to prevent condensation or other deposition of the gas/aerosol in use on, for example, the surface of a heater provided in an aerosol generating assembly. Thus, consumption efficiency and hygiene can be improved in some cases.

In some cases, the surface of the support that abuts the aerosol-generating material may be porous. For example, in one case, the support comprises paper. It has been found that a porous support such as paper is particularly suitable for the present disclosure; the porous (e.g. paper) layer abuts the aerosol-generating material and forms a strong bond. The aerosol-generating material is formed by drying a gel and, without being limited by theory, it is thought that the slurry from which the gel is formed partially impregnates the porous support (e.g. paper) so that when the gel sets and forms cross-links, the support is partially bound into the gel. This provides a strong binding between the gel and the support (and between the dried gel and the support).

In one particular case, the support may be a paper-backed foil; the paper layer abuts the aerosol-generating material and the properties discussed in the previous paragraphs are afforded by this abutment. The foil backing is substantially impermeable, providing control of the aerosol flow path. A metal foil backing may also serve to conduct heat to the aerosol-generating material.

In another case, the foil layer of the paper-backed foil abuts the aerosol-generating material. The foil is substantially impermeable, thereby preventing water provided in the aerosol-generating material to be absorbed into the paper which could weaken its structural integrity.

In some cases, the support is formed from or comprises metal foil, such as aluminum foil. A metallic support may allow for better conduction of thermal energy to the. Additionally, or alternatively, a metal foil may function as a susceptor in an induction heating system. In particular embodiments, the support comprises a metal foil layer and a support layer, such as cardboard. In these embodiments, the metal foil layer may have a thickness of less than 20 μm, such as from about 1 μm to about 10 μm, suitably about 5 μm.

In some cases, the support may have a thickness of between about 0.010 mm and about 2.0 mm, suitably from about 0.015 mm, 0.02 mm, 0.05 mm or 0.1 mm to about 1.5 mm, 1.0 mm, or 0.5 mm.

Further embodiments are contemplated wherein non-square inductor coil arrangements are provided. It will be understood that this relates to one turn.

In particular, embodiments are contemplated wherein two or more turns are provided so that a two layer or multilayer arrangement is provided. According to this embodiment the vast majority of the arrangement comprises PCB material type.

It is also contemplated that the coil arrangement may comprise one or more loops.

While the above-described embodiments have in some respects focused on some specific example aerosol generating systems, it will be appreciated the same principles can be applied for aerosol generating systems using other technologies. That is to say, the specific manner in which various aspects of the aerosol generating provision system function are not directly relevant to the principles underlying the examples described herein.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

1. An aerosol generating device, the device comprising:
a device housing;
a planar non-spiral inductor coil; and
a power supply connected to the planar non-spiral inductor coil, the power supply configured to provide an oscillating current to the planar non-spiral inductor coil.

2. The aerosol generating device as claimed in claim 1, the aerosol generating device further comprising, in use, an aerosolizable material and one or more susceptors positioned to heat the aerosolizable material.

3. The aerosol generating device as claimed in claim 1, wherein the inductor coil is substantially square or substantially rectangular.

4. (canceled)

5. The aerosol generating device as claimed in claim 1, wherein the aerosol generating device comprises two or more planar non-spiral inductor coils.

6. The aerosol generating device as claimed in claim 1, further comprising a flux concentrator.

7. The aerosol generating device as claimed in claim 6, wherein the flux concentrator comprises at least one of a ferrite material or is a continuous sheet or strip of a ferrite material.

8. The aerosol generating device as claimed in claim 1, wherein the inductor coil comprises a plurality of mandrel loops or loops, the plurality of mandrel loops or loops being arranged in a multiple layer configuration.

9. The aerosol generating device as claimed in claim 8, wherein the mandrel loops or loops comprise single turn coils, two turn coils, three turn coils, or four turn coils.

10. (canceled)

11. The aerosol generating device as claimed in claim 8, wherein the mandrel loops or loops are disposed on a printable circuit board (PCB).

12. The aerosol generating device as claimed in claim 1, wherein the aerosol generating device comprises a plurality of planar non-spiral inductor coils.

13. The aerosol generating device as claimed in claim 1, wherein the one or more planar non-spiral inductor coils are configured to generate a varying magnetic field, wherein the one or more planar non-spiral inductor coils are configured to generate a respective varying magnetic field from each one of the planar non-spiral induction coils, and wherein each of the respective varying magnetic fields are generated independently of each other.

14. The aerosol generating device as claimed in claim 13, wherein the one or more susceptors are arranged to become heated by the varying magnetic field.

15-18. (canceled)

19. An aerosol generating system comprising:
the aerosol generating device as claimed in claim 1; and
an article for use with a non-combustible aerosol provision device.

20. The aerosol generating system as claimed in claim 19, wherein the article for use with a non-combustible aerosol provision device comprises one or more susceptors, and wherein the one or more planar non-spiral inductor coils are configured to generate a varying magnetic field and wherein the one or more susceptors are arranged to become heated by the varying magnetic field.

21. The aerosol generating system as claimed in claim 19, wherein the article for use with a non-combustible aerosol provision device comprises aerosolizable material.

22. The aerosol generating system as claimed in claim 21, wherein the aerosolizable material is provided as at least one of: a solid; a liquid; in the form of a gel; in the form of a thin film substrate; in the form of a thin film substrate having multiple regions; or in the form of a thin film substrate having multiple regions, wherein at least two of the regions comprise aerosolizable material having different compositions.

23. A method of generating an aerosol comprising:
providing the aerosol generating device as claimed in claim 1; and
inserting an article for use with a non-combustible aerosol provision device comprising aerosolizable material into the aerosol generating device.

24. An aerosol generating system comprising:
an aerosol generating device comprising one or more planar non-spiral inductor coils;
an article for use with a non-combustible aerosol provision device located, in use, within the aerosol generating device; and
one or more removable susceptors.

25. An aerosol generating system comprising:
an aerosol generating device; and
an article for use with a non-combustible aerosol provision device located, in use, within the aerosol generating device, wherein the article for use with a non-combustible aerosol provision device comprises one or more planar non-spiral inductor coils and one or more susceptors.

26. (canceled)

27. An aerosol provision device comprising:
a plate or printed circuit board having an aperture for receiving an aerosol generating article;
a first planar non-spiral inductor coil provided on a first side of the plate or printed circuit board; and
a second planar non-spiral inductor coil provided on a second opposite side of the plate or printed circuit board.
